(19) United States
(12) Patent Application Publication
(10) Pub. No.: US 2025/0059415 A1
(43) Pub. Date: Feb. 20, 2025

(54) CURABLE ORGANOPOLYSILOXANE COMPOSITION AND ADHESIVE COMPOSITION CONTAINING SAME

(71) Applicant: DOW TORAY CO., LTD., Shinagawa-ku, Tokyo (JP)

(72) Inventors: Yuki YOKOUCHI, Ichihara-shi, Chiba (JP); Tomohiro IIMURA, Ichihara-shi, Chiba (JP)

(21) Appl. No.: 18/723,424

(22) PCT Filed: Dec. 15, 2022
(86) PCT No.: PCT/JP2022/046170

§ 371 Date: Jun. 22, 2024

(30) Foreign Application Priority Data
Dec. 24, 2021 (JP) 2021-210695

(51) Int. Cl. C09J 153/00; C08K 5/07; C09J 5/00; C09J 7/38; C09J 11/08

(52) U.S. Cl. CPC C09J 153/005; C08K 5/07; C09J 5/00; C09J 7/387; C09J 11/08; C09J 2203/37; C09J 2301/414; C09J 2301/416; C09J 2301/502; C09J 2453/00

(57) ABSTRACT

Provided is a curable organopolysiloxane composition that has strong initial pressure-sensitive adhesive strength in a process such as temporary fixing or the like, and that is easily peelable from a substrate in a subsequent process. Also provided is a method for using the composition. A curable organopolysiloxane composition including: (A) an organosiloxane component containing a silicon atom-bonded functional group (R^{A}) containing a specific (meth)acrylic group, a resinous organosiloxane structure factor containing an alkenyl group, and a chain organopolysiloxane structure factor, (B) a siloxane component not containing a carbon-carbon multiple bond in each molecule, and (C) a photo-radical polymerization initiator; and use thereof.

### TECHNICAL FIELD

The present invention relates to a curable organopolysiloxane composition primarily containing a siloxane component (which may be a copolymer or a mixture) containing a (meth)acrylic functional group and another aliphatic unsaturated carbon-carbon bond-containing group, that provides a pressure-sensitive adhesive layer having a relatively strong initial adhesive strength due to a heat curing reaction, and by performing a photocuring reaction after the heat curing reaction, the pressure-sensitive adhesive strength of the adhesive agent to a substrate changing before and after the photocuring reaction. The present invention also relates to an organopolysiloxane pressure-sensitive adhesive composition containing the curable organopolysiloxane composition, and a method of use thereof. Note that in the present invention, the pressure-sensitive adhesive includes a so-called pressure-sensitive adhesive (=PSA).

### BACKGROUND ART

Organopolysiloxane pressure-sensitive adhesive compositions are superior to acrylic and rubber pressure-sensitive adhesive compositions in electrical insulation, heat resistance, cold resistance, pressure-sensitive adhesion to various adherends, and transparency, if necessary, and thus are widely used in the manufacture of semiconductor wafers, electronic and electrical devices such as smartphones, tablet PCs and the like, and display devices such as displays and the like. In particular, in recent years, since a member or a protective film is temporarily fixed with a relatively weak adhesive force and the temporarily fixed member or the like is peeled off from an adhesive according to the progress of a step in processing of a semiconductor wafer or an assembling step of electronic and electrical devices or a display, a composition forming a pressure-sensitive adhesive with slight pressure-sensitive adhesion as compared with a conventional organopolysiloxane pressure-sensitive adhesive composition is required.

In particular, in recent years, in semiconductor wafer processing and the like, a pressure-sensitive adhesive sheet obtained by applying a pressure-sensitive adhesive onto a substrate made of a film has been used in a dicing/pickup/mounting step after a step of grinding a back surface of a semiconductor wafer. In these steps, there is a case where pressure-sensitive adhesive strength is required and a case where easy releasability is required. In other words, of these steps, the step of grinding the back surface of the semiconductor wafer requires that the pressure-sensitive adhesive sheet be sufficiently adhered to the semiconductor wafer without being peeled off in order to protect the pattern surface of the semiconductor wafer. In addition, easy peeling must be possible from the semiconductor wafer after grinding. Similarly, in the dicing step of the semiconductor wafer, high pressure-sensitive adhesion is required such that cut and separated element pieces do not peel off from the pressure-sensitive adhesive sheet. On the other hand, in the pickup step, the cut and separated small element pieces must be easily peeled off from the pressure-sensitive adhesive sheet. In other words, the pressure-sensitive adhesive sheet is required to have pressure-sensitive adhesion.

However, there is a trade-off relationship between the pressure-sensitive adhesive strength for the purpose of fixing or protection and the ease of peeling of a member, and when a pressure-sensitive adhesive with slight pressure-sensitive adhesion is used, the pressure-sensitive adhesive strength is insufficient in a step in which the pressure-sensitive adhesive strength is required for temporary fixing or the like, which may cause process failure. On the other hand, when the pressure-sensitive adhesive strength is high, peeling in a post-process may become difficult, or a problem of process failure due to adhesive residue caused by breakage of the aggregated layer may occur. Therefore, there is a demand for a pressure-sensitive adhesive which has a necessary and sufficient pressure-sensitive adhesive strength in a step such as temporary fixing or the like and which can be very easily peeled off from a substrate in a subsequent step.

On the other hand, active energy beam-curable and re-releasable pressure-sensitive adhesives have been proposed in the fields of film materials, electrode materials, and the like (e.g., Patent Documents 1 to 3). By using an acrylic copolymer or polyurethane copolymer, these pressure-sensitive adhesives can significantly change their adhesive properties before and after active energy beam irradiation, can develop high pressure-sensitive adhesion before active energy beam irradiation, and can develop high releasability after active energy beam irradiation. However, the pressure-sensitive adhesives described in these documents have an organic molecular skeleton. Therefore, there is still room for improvement in applications intended to protect substrates during processing, particularly in terms of heat resistance and durability.

On the other hand, Patent Document 4 proposes: an organopolysiloxane composition containing an organopolysiloxane compound containing a (meth)acrylic functional group, a platinum-based catalyst and a photoinitiator, the composition being capable of a curing reaction by a photo-polymerization reaction and addition reaction, and having excellent heat resistance, discoloration resistance and low tack properties; and a sealing agent containing a cured product thereof.

However, these documents do not specifically disclose a siloxane component containing a (meth)acrylic functional group and an alkenyl group, or the like (in particular, resin-linear structure-containing organopolysiloxane block copolymer and siloxane mixture), and in particular, there is no description nor suggestion of such a pressure-sensitive adhesive composition containing such a siloxane component or features related to curing thereof (especially two-stage curing and changes in pressure-sensitive adhesive strength).

In response, in order to solve the aforementioned problem, the patent applicant has proposed a covalent organopolysiloxane containing a (meth)acrylic functional group and an alkenyl group, or the like, and a curable organopolysiloxane composition containing the organopolysiloxane, which has both heat-curing and light-curing properties (Patent Document 5 and Patent Document 6). The composition is one in which a pressure-sensitive adhesive layer is formed by a heat curing reaction, as a semi-cured product, and then by performing a light curing reaction to fully cure, the pressure-sensitive adhesive strength of the pressure-sensitive adhesive layer to the substrate decreasing markedly before and after the light curing reaction. However, the initial adhesive strength is not that high, leaving room for further improvement.

### RELATED ART DOCUMENTS

### Patent Documents

Patent Document 1: Japanese Unexamined Patent Application Publication 2012-012545
Patent Document 2: Japanese Unexamined Patent Application Publication 2012-136678
Patent Document 3: Japanese Unexamined Patent Application Publication 2013-166877
Patent Document 4: Japanese Unexamined Patent Application Publication 2013-203794
Patent Document 5: Japanese Patent Application 2021-34958 (unpublished at the time of filing)
Patent Document 6: Japanese Patent Application 2021-34959 (unpublished at the time of filing)

### SUMMARY OF THE INVENTION

### Problem to be Solved by the Invention

An object of present invention is to solve the problems, and to provide a curable organopolysiloxane composition which has a relatively strong initial adhesive strength and provides a pressure-sensitive adhesive layer, which is very easily peelable from a substrate in a subsequent process, an organopolysiloxane pressure-sensitive adhesive composition containing the curable organopolysiloxane composition, and a method of using the organopolysiloxane adhesive composition.

### Means for Solving the Problem

As a result of conducting diligent research on the problem described above, the present inventors arrived at the present invention. In other words, the object of the present invention can be achieved by a curable organopolysiloxane composition and an organopolysiloxane pressure-sensitive adhesive composition containing: a siloxane component having a silicon atom-bonded functional group having a specific acrylic group or methacrylic group and a silicon atom-bonded functional group having at least one aliphatic unsaturated carbon-carbon bond, and having a resinous organopolysiloxane structure and a linear siloxane structure (which may be a resin-linear structure-containing organopolysiloxane block copolymer or a mixture of different organosiloxanes), not having a carbon-carbon multiple bond in each molecule, as an adhesion-imparting component; and a photoradical polymerization initiator.

The curable organopolysiloxane composition of the present invention has both heat-curing and light-curing properties, and the pressure-sensitive adhesive layer, which is a semi-cured product cured by the heat-curing reaction and has a relatively strong initial adhesive strength of 30 gf/25 mm or more, and is completely cured by a subsequent light-curing reaction, causing a significant reduction in the adhesive strength of the pressure-sensitive adhesive layer to the substrate before and after the light curing reaction. As a result, the pressure-sensitive adhesive layer according to the present invention has a necessary and sufficient pressure-sensitive adhesive strength after heat curing, and is then irradiated with a high energy beam to be photo-cured, whereby the pressure-sensitive adhesive strength is reduced and easy releasability can be realized.

### Effect of the Invention

The present invention can provide a curable organopolysiloxane composition having both heat-curing and light-curing properties, the semi-cured product after heat curing having a relatively strong initial adhesive strength of 30 g/25 mm or more, and the cured product after light-curing reaction having a property of being very easily peelable from a substrate, as well as an organopolysiloxane adhesive, and a method of use thereof.

In particular, the curable organopolysiloxane composition of the present invention can provide a coatable viscosity, excellent curability, and can provide a cured product (particularly, a cured product film) having favorable adhesion to a substrate and excellent transparency by a curing reaction. Furthermore, the present invention can realize a silicone-based pressure-sensitive adhesive layer/adhesion layer whose pressure-sensitive adhesive strength changes before and after a photo-curing reaction, and can provide: a use as a protective member in a wide range of applications; and a manufacturing method and a protection method including an apparatus or a device provided with the same.

### DESCRIPTION OF THE PREFERRED EMBODIMENTS

The curable organopolysiloxane composition of the present invention contains:
(A) an organosiloxane component having one or more specific silicon-bonded (meth)acryl group, alkenyl group, or the like, and having a resinous organopolysiloxane structure and a linear siloxane structure in the component (selected from (A1) resin-linear structure containing—organopolysiloxane block copolymers and (A2/A3) organosiloxane mixtures);
(B) a siloxane component not containing a carbon-carbon multiple bond in each molecule; and
(C) a photoradical polymerization initiator and preferably also contains:
(D) specific MQ-type organopolysiloxane resins containing an alkenyl group,
(E) an organohydrogenpolysiloxane having at least 2 silicon-bonded hydrogen atoms in each molecule;
(F) a hydrosilylation reaction catalyst; and optional components such as curing retardants, organic solvents, and the like.

Furthermore, in the present specification, “(meth) acrylic group” refers to an “acrylic group or methacrylic group”. Each component is described below.

### [Component (A)]

Component (A) is a main component of the present composition and is a siloxane component containing a silicon-bonded functional group containing a (meth)acrylic group and a silicon-bonded functional group containing at least one aliphatic unsaturated carbon-carbon bond such as an alkenyl group or the like, and having a resinous organopolysiloxane structure and a linear siloxane structure in the same component. In component (A), the silicon-bonded functional group containing a (meth)acryl group must be bonded to the resinous organopolysiloxane structure, but the alkenyl group may be present in the same molecule or in another siloxane component. In other words, component (A) may be a covariant type resin-linear structure-containing organopolysiloxane block copolymer having these functional groups in one molecule, or may be an organosiloxane mixture containing a (meth)acrylic group-containing resinous organopolysiloxane and a linear or resinous organopolysiloxane having other functional groups.

More specifically, component (A) is one or more (meth)acrylic group-containing organosiloxane component selected from the following component (A1) to component (A3). In other words, component (A1) is a resin-linear structure-containing organopolysiloxane block copolymer, component (A2) is a mixture of (A2-1) a (meth)acryl and alkenyl group-containing resinous organopolysiloxane and (A2-2) a linear organopolysiloxane having two alkenyl groups in a molecule, and component (A3) is a mixture of (A3-1) a (meth)acryl group-containing resinous organopolysiloxane, (A3-2) an alkenyl group-containing resinous organopolysiloxane, and (A3-3) a linear organopolysiloxane having two alkenyl groups. Here, the (A2-2/A3-3) linear organopolysiloxane having two alkenyl groups in each molecule may be a linear organopolysiloxane having an alkenyl group only at both terminals of the molecular chain, and functions as an intermolecular chain extender during curing. Note that components (A2-1), (A3-1), and (A3-2) are MQ-type resinous organopolysiloxanes which will be described later and may contain a monoorganosiloxy unit (T unit), a diorganosiloxy unit (D unit), and a small amount of a hydrolyzable group such as a hydroxyl group (silanol group), alkoxy group, or the like, to the extent that the technical effects are not impeded, and may be a resinous organopolysiloxane where the amount of hydroxyl groups and hydrolyzable groups has been reduced by hydrolysis of the hydrolyzable groups using a silylating agent such as trimethylsilane or the like.

Component (A) as a whole is characterized by containing a silicon-bonded functional group (R^{A}) containing an acrylic group or a methacrylic group, and an alkenyl group. Herein, the silicon-bonded functional group (R^{A}) is a functional group exhibiting photo-curability by irradiation with a high energy beam in the presence of a photo-radical polymerization initiator, and the alkenyl group is a functional group exhibiting heat curability in the presence of a hydrosilylation reaction catalyst. The curable organopolysiloxane composition of the present invention has both a heat-curable and a photo-curable silicon-bonded functional group in component (A). Therefore, a pressure-sensitive adhesive layer formed from a semi-cured product after a heat curing reaction has a high initial adhesive strength due to the concomitant present of component (B) described below, and when the semi-cured product is irradiated with a high energy beam, the pressure-sensitive adhesive strength is greatly reduced, and easy peelability can be achieved.

Furthermore, component (A) has in whole, a linear organopolysiloxane structure, a (meth)acrylic group-containing resinous organopolysiloxane structure, and an alkenyl group-containing resinous organopolysiloxane structure, so the semi-cured product obtained by heat curing exhibits appropriate hardness and flexibility and can be suitably used as a pressure-sensitive adhesive. In other words, each of the components (A1) to (A3) that can be used as component (A) is different depending on whether a block copolymer in which the structural factor and the functional group are aggregated in the same molecule is selected as the main component or a mixture of siloxane raw materials each having one characteristic, is selected as the main component to provide the technical effects of the present invention.

Herein, the silicon-bonded functional group (R^{A}) containing an acrylic group or methacrylic group in component (A) is expressed by General Formula (1):

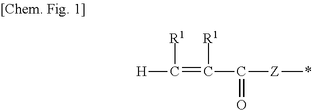

In the formula, R¹ mutually independently represents a hydrogen atom, a methyl group, or a phenyl group, and preferably a hydrogen atom or a methyl group in order to form an acrylic group or a methacrylic group moiety. Z represents a divalent organic group which may contain a hetero atom and is bonded to a silicon atom configuring the main chain of the polysiloxane represented by *, and may be a divalent organic group which may contain an oxygen atom, a nitrogen atom or a sulfur atom.

Herein, Z is preferably one or more type of group selected from:
alkylene groups with 2 to 22 carbon atoms;
divalent organic groups expressed by —R³—C(═O)—O—R⁴— {where R³ represents an alkylene group having 2 to 22 carbon atoms, and R⁴ is a group selected from ethylene groups, propylene groups, methylethylene groups, and hexylene groups}; and
divalent organic groups expressed by —Z¹—X—C(═O)—X—Z²— {where Z¹ represents —O(CH₂)ₖ— (k is a number in the range of 0 to 3), and X represents an oxygen atom, a nitrogen atom, or a sulfur atom. Z² represents a divalent organic group expressed by —[(CH₂)₂O]ₘ(CH₂)ₙ— (where m is a number in a range 0 to 3, n is a number in a range 3 to 10) bonded to a silicon atom forming the main chain of the polysiloxane represented by *}.

Particularly preferably, the silicon atom-bonded functional group (R^{A}) is expressed by general formula (1-1):

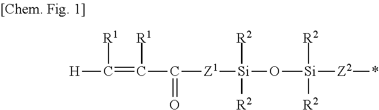

In the formula, R¹ mutually independently represents a hydrogen atom, a methyl group, or a phenyl group, and preferably a hydrogen atom or a methyl group. R² mutually independently represents an alkyl group or an aryl group, preferably an alkyl group or a phenyl group having 1 to 20 carbon atoms for industrial purposes, and particularly preferably a methyl group. Z¹ represents —O(CH₂)ₘ— (m is a number in the range 0 to 3), where m is preferably 1 or 2. Z² represents a divalent organic group expressed by —(CH₂)ₙ— (n is a number in a range of 3 to 10) bonded to a silicon atom configuring the main chain of the polysiloxane represented by *, and a case where n is 2 to 6 is preferred for practical use. It should be noted that the silicon atom-bonded functional group (R^{A}) expressed by general formula (1-1) can be introduced into a molecule by reacting a silicon atom-bonded functional group containing at least one alkenyl group and a hydrosilane compound having a silicon atom-bonded hydrogen atom and (meth)acryl functional group in a molecule (e.g., 3-(1,1,3,3-tetramethyldisiloxanyl)propyl=methacrylate and the like), in the presence of a hydrosilylation reaction catalyst. Furthermore, the same reaction may be and preferably is performed in the presence of a polymerization inhibitor such as dibutylhydroxytoluene (BHT).

The alkenyl group in component (A) is preferably an alkenyl group having 2 to 20 carbon atoms, with examples including vinyl groups, allyl groups, butyl groups, hexenyl groups, and the like. A vinyl group or a hexenyl group is particularly preferable from the perspective of crosslinking reactivity.

Component (A1) is a resin-linear structure-containing organopolysiloxane block copolymer having: a resinous organosiloxane block X having an acrylic group or methacrylic group and containing a siloxane unit (M^{RA} unit) expressed by R^{A}ₐR^{B}₍₃₋ₐ₎SiO_{1/2} (where R^{A} is a silicon atom-bonded functional group containing an acrylic or methacrylic group, R^{B} is a monovalent organic group excluding R^{A}, and a is a number in a range of 1 to 3),
a siloxane unit (M^{Alk} unit) expressed by R^{B′}3SiO_{1/2} (where R^{B′} is a monovalent organic group excluding R^{A} and at least one R^{B′} is an alkenyl group) and a siloxane unit (Q unit) expressed by SiO_{4/2}; and
a chain organosiloxane block Y having a siloxane unit expressed by {R^{C}₂SiO_{2/2}}_{β} (where R^{C} is a monovalent organic group and β is 2 or higher), and having at least 2 alkenyl groups in each molecule. The ratio of block X to block Y in the component (A1) may be in a range of 1:99 to 80:20, and is more preferably in the range of 20:80 to 60:40.

With respect to the resinous organosiloxane block X, R^{B}, and R^{B′} in the above formula are monovalent organic groups other than the aforementioned R^{A}, and examples thereof include monovalent hydrocarbon groups selected from alkyl groups, alkenyl groups, aryl groups, aralkyl groups, and halogenated alkyl groups in which some of the hydrogen atoms are substituted with halogen atoms such as fluorine atoms. Note that at least one of R^{B′} is an alkenyl group. Industrially, R^{B} may be an alkyl group (particularly including methyl groups) or a phenyl group, at least one of R^{B′} may be an alkenyl group with 2 to 8 carbon atoms (C2 to C8 alkenyl), preferably a vinyl or a hexenyl group, and the other R^{B′} may be an alkyl group (particularly including methyl groups) or a phenyl group. a is in a range of 1 to 3, preferably 1.

Furthermore, the resinous organosiloxane block X may include a siloxane unit (M unit) expressed by R^{B″}₃SiO_{1/2} (where R^{B″} is an alkyl group or a phenyl group). Industrially, the M unit is expressed by (CH₃)₃SiO_{1/2}.

The resinous organosiloxane block X constituting the component (A1) preferably contains M^{RA} units, M^{Alk} units, and optionally M units and Q units, and the sum of the amounts of M units, M^{RA} units, and M^{Alk} units relative to 1 mol of Q units is in a range of 0.5 to 2.0 mol. As an example, the M^{RA} units constituting the resinous organosiloxane block X can be R^{A}(CH₃)₂SiO_{1/2} and the M^{Alk} unit is a (C2 to C8 alkenyl) (CH₃)₂SiO_{1/2}. In addition, in the resinous organosiloxane block X, the amount of M^{RA} unit relative to 1 mol of Q units is particularly preferably in a range of 0.02 to 0.50 mol, from the viewpoint of reactivity.

The chain-like organosiloxane block Y has a diorganopolysiloxane structure, and R^{C} in the above formula is a monovalent organic group, for example, a monovalent hydrocarbon group selected from the aforementioned functional group R^{A}, alkyl groups, alkenyl groups, aryl groups, aralkyl groups, and halogenated alkyl groups in which a portion of the hydrogen atoms are substituted with a halogen atom such as a fluorine atom. Industrially, a methyl group or a phenyl group can be used. p is a number that is 2 or more, representing the number of repeating units of diorganosiloxy units, and may be a number in a range of 2 to 10000, 5 to 5000, 5 to 1000, 5 to 500, 5 to 250, 10 to 200, or 10 to 150.

The linking group between the silicon atom comprising the resinous organosiloxane block X of component (A1) and the aforementioned chain-type organosiloxane block Y are not particularly restricted, but may be and is preferably a resin-linear structure containing—organopolysiloxane block copolymer having a structure linked by a siloxane bond or silalkylene bond. These linking groups can be introduced between molecules by a condensation reaction or a hydrosilylation reaction of precursor compounds of block X and block Y, and block X and block Y are particularly preferably linked by a siloxane bond between silicon atoms by a condensation reaction of the precursor compounds of both blocks.

The siloxane degree of polymerization of the block copolymer, which is component (A1) according to the present invention, is not particularly limited, but is preferably in a range of 10 to 10,000, and more preferably in a range of 25 to 2,000, from the perspective of imparting a coatable viscosity to the curable organopolysiloxane composition containing the co-modified organopolysiloxane. In particular, when an organopolysiloxane with a high degree of polymerization exceeding the aforementioned upper limit is used, coating the curable organopolysiloxane composition may be difficult without the use of organic solvents or diluents.

Component (A2) is an organosiloxane mixture of the following component (A2-1) and component (A2-2) at a mass ratio of 1:99 to 80:20, and the mass ratio may be 20:80 to 60:40. Here, component (A2-1) is a resinous organopolysiloxane having an M^{RA} unit containing the functional group R^{A} and an M^{Alk} unit containing an alkenyl group, and component (A2-2) is a component that provides a linear organopolysiloxane structure by a chain extending reaction.

Component (A2-1) is a resinous organopolysiloxane having an acrylic group or methacrylic group and containing a siloxane unit (M^{RA} unit) expressed by R^{A}ₐR^{B}₍₃₋ₐ₎SiO_{1/2} (where R^{A} is a silicon atom-bonded functional group containing an acrylic or methacrylic group, R^{B} is a monovalent organic group excluding R^{A}, and a is a number in a range of 1 to 3), a siloxane unit (M^{Alk} unit) expressed by R^{B′}₃SiO_{1/2} (where R^{B′} is a monovalent organic group excluding R^{A} and at least one R^{B′} is an alkenyl group) and a siloxane unit (Q unit) expressed by SiO_{4/2}. Herein, R^{A}, R^{B}, and R^{B′} are the same groups as described above, and a is the same number as described above. Furthermore, component (A2-1) may be an organopolysiloxane resin containing the aforementioned M^{RA} units, M^{Alk} units, Q units, and optionally M units, wherein the sum of the amounts of M units, M^{RA} units, and M^{Alk} units per mole of Q units is in a range of 0.5 to 2.0 moles, and may be an organopolysiloxane resin where the amount of M^{RA} units per mole of Q units is in a range of 0.02 to 0.50 moles.

Component (A2-2) is a linear organopolysiloxane having two alkenyl groups in each molecule, preferably having alkenyl groups only at both ends of the molecular chain. More specifically, an example is a polydimethylsiloxane sealed at both ends of the molecular chain with dialkylalkenylsiloxy groups, industrially with a (C2 to C8 alkenyl) dimethylsiloxy unit expressed by (C2 to C8 alkenyl)(CH₃)₂SiO_{1/2}. Herein, the degree of polymerization of the diorganosiloxane of component (A2-2) is not particularly limited, but may be a number in the range of 2 to 10000, 5 to 5000, 5 to 1000, 5 to 500, 5 to 250, 10 to 200, or 10 to 150, from the viewpoint of coatability. On the other hand, linear organopolysiloxanes with more than 2 alkenyl groups in each molecule may not fully demonstrate the technical effects of the present invention, such as initial adhesive strength, because they use three-dimensional cross-linking reactions rather than two-dimensional intermolecular chain extending reactions.

Component (A3) is an organosiloxane mixture obtained by mixing the following components (A3-1) to (A3-3). Here, component (A3-1) is a resinous organopolysiloxane having an M^{RA} unit containing the functional group R^{A}; component (A3-2) is a resinous organopolysiloxane having an M^{Alk} unit containing an alkenyl group; and component (A3-3) is a component that provides a linear organopolysiloxane structure by a chain extending reaction. Herein, the mixing ratio of the respective components is not particularly limited, but the mass ratio of (A3-1)+(A3-2):(A3-3) may be in the range of 1:99 to 80:20, preferably in a range of 20:80 to 60:40, and the mass ratio of (A3-1) and (A3-2) may be in a range of 10:90 to 90:10.

Component (A3-1) a resinous organosiloxane having an acrylic group or methacrylic group and containing a siloxane unit (M^{RA} unit) expressed by R^{A}ₐR^{B}₍₃₋ₐ₎SiO_{1/2} (where R^{A} is a silicon atom-bonded functional group containing an acrylic or methacrylic group, R^{B} is a monovalent organic group excluding R^{A}, and a is a number in a range 1 to 3), and siloxane units (Q units) expressed by SiO_{4/2}, wherein R^{A} and R^{B} are the same groups as described above, and a is as described above. Furthermore, component (A3-1) may be an organopolysiloxane resin containing the aforementioned M^{RA} units, 0 units, and optionally M units, wherein the sum of the amounts of M units and M^{RA} units per moles of Q units is in a range of 0.5 to 2.0 moles, and may be an organopolysiloxane resin where the amount of M^{RA} units per mole of Q units is in a range of 0.02 to 0.50 moles.

Component (A3-2) is a resinous organopolysiloxane having an alkenyl group and containing a siloxane unit (M^{Alk} unit) expressed by R^{B′}₃SiO_{1/2} (where R^{B′} is a monovalent organic group other than R^{A}, and at least one of R^{B′} is an alkenyl group), and a siloxane unit (Q unit) expressed by SiO_{4/2}, wherein R^{B′} is the same group as described above, and a is as described above. Furthermore, component (A3-2) may be an organopolysiloxane resin containing the aforementioned M^{Alk} units, Q units, and optionally M units, wherein the sum of the amounts of M units and M^{Alk} units per moles of Q units is in a range of 0.5 to 2.0 moles.

Component (A3-3) is a linear organopolysiloxane having two alkenyl groups in each molecule, preferably having alkenyl groups only at both ends of the molecular chain. These components are the same as those exemplified above for component (A2-2).

### [Component (B)]

Component (B) is a non-reactive or low-reactive siloxane component used in combination with component (A), and is one characteristic feature of the present invention. Component (B) is an adjusting agent for the pressure-sensitive adhesion including the initial adhesion of the pressure-sensitive adhesive layer that is semi-cured by the heat curing reaction of this composition. The pressure-sensitive adhesive layer containing component (B) exhibits high initial adhesion, but has a characteristic where the pressure-sensitive adhesive strength to the substrate changes significantly due to the light curing reaction that occurs in conjunction with irradiation by a high energy beam.

More specifically, component (B) is a siloxane component that does not contain a carbon-carbon multiple bond in the molecule, and is clearly distinguished from component (A) (and constituent components) and component (D) described below by not having the functional group R^{A} or an alkenyl group. More specifically, component (B) is one or more siloxane component not having a carbon-carbon multiple bond, selected from the following component (B1) to component (B3).

Component (B1) is an MQ type organopolysiloxane and is a component for improving the pressure-sensitive adhesive strength of the cured layer. Specifically, component (B1) contains a siloxane unit (M unit) expressed by R₃SiO_{1/2} (in the formula, R represents mutually independent monovalent organic groups that do not contain a carbon-carbon multiple bond) and a siloxane unit (Q unit) expressed by SiO_{4/2} in each molecule, wherein the ratio of M units to moles of Q units is in a range of 0.5 to 2.0, and R is a monovalent hydrocarbon group selected from alkyl groups, aryl groups, aralkyl groups, and halogenated alkyl groups in which a portion of the hydrogen atoms are replaced by a halogen atom such as a fluorine atom. Industrially, a methyl group or a phenyl group may be used. Furthermore, a small amount of hydroxyl groups (silanol groups) or alkoxy groups may be included in component (B1), and if necessary, the amount of hydroxyl groups or hydrolyzable groups may be reduced by hydrolyzing these hydrolyzable groups using a silylating agent such as trimethylsilane.

Component (B2) is a linear or branched diorganopolysiloxane not containing a carbon-carbon multiple bond in the molecule, and is a component for adjusting the pressure-sensitive adhesive strength of the cured layer. Component (B2) can be a linear or branched dimethylpolysiloxane having a functional group selected from monovalent hydrocarbon groups chosen from hydroxyl groups (silanol groups), alkyl groups, aryl groups, aralkyl groups, and alkyl halide groups in which a portion of the hydrogen atoms are replaced by a halogen atom such as a fluorine atom or the like. Industrial examples include linear or branched dimethylpolysiloxane, which may have a silanol group in each molecule. Furthermore, from the viewpoint of adjusting the pressure-sensitive adhesive strength of the cured layer, component (B2) may be a diorganopolysiloxane with a relatively high degree of polymerization, and may be a diorganopolysiloxane with a number average molecular weight of 100000 or more. Component (B2) may preferably be a gum-like diorganopolysiloxane having a viscosity between 1000000 MPa·s or more at room temperature and plasticity. Herein, “having plasticity” means that the plasticity can be measured in accordance with the method specified in JIS K6249 (determine the thickness to 1/100 mm when a load of 1 kgf is applied to a spherical sample of 4.2 g for 3 minutes at 25° C., and multiply this value by 100), and in particular, component (B2) may be a raw rubber-like polydimethylsiloxane with a plasticity in a range of 50 to 200.

Component (B3) is a condensation reaction product of component (B1) and component (B2), and is particularly preferably a component for adjusting the pressure-sensitive adhesive strength of the cured layer. Component (B3) can be obtained by a condensation reaction of the above component (B1) or component (B2) which has a hydrolyzable functional group such as a silanol group in the molecule using known methods, and condensation reactants with a relatively high degree of polymerization are preferred, and condensation reaction products of the component (B1) and component (B2) with a number average molecular weight after condensation of 100000 or more are preferable. These condensation products having a high degree of polymerization and a high molecular weight can be easily obtained by subjecting component (B1) and component (B2) having a relatively high molecular weight as starting components to a condensation reaction in the presence of a known condensation reaction catalyst.

The curable organopolysiloxane composition of the present invention or the organopolysiloxane pressure-sensitive adhesive composition containing the same may contain one or more components selected from the aforementioned component (B2) and component (B3) as at least a portion or all of component (B). The pressure-sensitive adhesive strength can be adjusted in the semi-cured product containing these components, and when the semi-cured product is cured by a photo-curing reaction accompanying irradiation with a high energy beam, a portion of these components exudes (bleeds out) to the surface of the cured layer to form a smooth surface, and the releasability from the substrate may be significantly improved in addition to a decrease in the pressure-sensitive adhesive strength due to the progress of the curing reaction.

In the curable organopolysiloxane composition of the present invention, the amount of component (B) used can be designed as appropriate in consideration of the desired initial adhesive strength and the peelability of the cured product after the photocuring reaction, and is in a range of 1 to 50 parts by mass, 5 to 40 parts by mass, or 10 to 30 parts by mass, relative to 100 parts by mass of component (A). Furthermore, component (B) is preferably component (B1) and one or more types selected from component (B2) and component (B3), used in combination, and the mass ratio between the two may be in a range of 50:50 to 95:5. Within this range, the peelability from the substrate will also be improved, in addition to the high initial adhesive strength and a large decrease in pressure-sensitive adhesive strength after the photo-curing reaction.

### [(C) Photoradical Polymerization Initiator]

Component (C) is a photo-radical polymerization initiator, which accelerates the photo-curing reaction of the acrylic group or methacrylic group of the silicon-bonded functional group (R^{A}) in component (A) by high energy beam irradiation. In particular, a cured product with easy releasability where the pressure-sensitive adhesive strength of the pressure-sensitive adhesive layer to the substrate is greatly reduced is formed by irradiating the pressure-sensitive adhesive layer containing a semi-cured product containing unreacted functional groups (R^{A}) derived from component (A) with high energy beams.

The photoradical polymerization initiators are known to be broadly classified into photo-fragmentation and hydrogen abstraction types. However, the photoradical polymerization initiator used in the composition of the present invention can be optionally selected from those known in the technical field, and is not limited in particular, and one that does not easily hinder a hydrosilylation reaction at 80° C. or higher is preferable. Examples of the photo-radical polymerization initiator include α-ketol compounds such as 4-(2-hydroxyethoxy)phenyl (2-hydroxy-2-propyl) ketone, α-hydroxy-α, α′-dimethylacetophenone, 2-methyl-2-hydroxypropiophenone, 1-hydroxycyclohexyl phenyl ketone, and the like; acetophenone compounds such as methoxyacetophenone, 2,2-dimethoxy-2-phenylacetophenone, 2,2-diethoxyacetophenone, 2-methyl-1-[4-(methylthio)-phenyl]-2-morpholinopropane-1, and the like; benzoin ether compounds such as benzoin ethyl ether, benzoin isopropyl ether, anisoin methyl ether, and the like; ketal compounds such as benzyl dimethyl ketal and the like; aromatic sulfonyl chloride compounds such as 2-naphthalenesulfonyl chloride and the like; photo-active oxime compounds such as 1-phenone-1,1-propanedione-2-(o-ethoxycarbonyl)oxime and the like; benzophenone compounds such as benzophenone, benzoylbenzoic acid, 3,3′-dimethyl-4-methoxybenzophenone, and the like; thioxanthone compounds such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and the like; camphorquinone; halogenated ketones; acyl phosphinoxides; acyl phosphonates; and the like.

The amount of component (C) used can be appropriately designed according to the amount of the silicon-bonded functional group (R^{A}) derived from component (A), as well as the desired change in the pressure-sensitive adhesive strength and ease of releasability of a cured product triggered by irradiation with a high energy beam, but is preferably 0.1 to 10 parts by mass, and particularly preferably 0.5 to 5 parts by mass, with respect to 100 parts by mass of component (A).

### [(C′) Photosensitizer]

Optionally, a photosensitizer (C′) may be used in combination with an optionally selected photoradical polymerization initiator (C). Use of a sensitizer can increase the photon efficiency of the polymerization reaction, and is particularly effective when the coating thickness of the composition is relatively thick or when a relatively long-wavelength LED light source is used, because use of longer wavelength light for the polymerization reaction compared to only using a photoinitiator is feasible. Examples of known sensitizers include anthracene-based compounds, phenothiazine-based compounds, perylene-based compounds, cyanine-based compounds, melocyanine-based compounds, coumarin-based compounds, benzylidene ketone-based compounds, and (thio)xanthene or (thio)xanthone-based compounds such as isopropylthioxanthone, 2,4-diethylthioxanthone, squarylium-based compounds, (thia)pyrylium-based compounds, porphyrin-based compounds, and the like. Moreover, an arbitrary photosensitizer not limited thereto can be used in the curable organopolysiloxane composition and adhesive composition of the present invention. The amount used is arbitrary, but is commonly selected within a range where the mass ratio of component (C′) to component (C) is 0 to 10, and if present, is within a range of 0.01 to 5.

### [(D) MQ-Type Organopolysiloxane Resin Containing Alkenyl Group]

Independent of components (A) to (C), the composition of the present invention can contain (D) an MQ type organopolysiloxane resin having an alkenyl group. Component (D) is a reactive component in a heat curing reaction, and is a component for optionally adjusting the adhesive strength to a substrate, and depending on the amount of the component used, can adjust the hardness of a semi-cured product after a hydrosilylation reaction and adhesion to the substrate.

More specifically, component (D) contains one or more alkenyl group in each molecule and includes (a) a siloxane unit (M unit) expressed by R₃SiO_{1/2} (in the formula, R represents a mutually independent monovalent organic groups), and (b) an organopolysiloxane resin containing a siloxane unit (Q unit) expressed by SiO_{4/2}. The molar ratio of M units to Q units is preferably 0.5 to 2.0. This is because when the molar ratio is less than 0.5, adhesion to the substrate of the cured product may be reduced, whereas when the molar ratio is greater than 2.0, the cohesive strength of material forming the adhesive layer decreases.

In particular, the molar ratio of (a) M units to (b) Q units is preferably within a range of M units:Q units=0.50:1.00 to 1.50:1.00, more preferably within a range of 0.55:1.00 to 1.20:1.00, and even more preferably within a range of 0.60:1.00 to 1.10:1.00. The molar ratio can be easily measured by ²⁹Si nuclear magnetic resonance.

Component (D) is preferably an organopolysiloxane resin expressed by general unit formula: (R₃SiO_{1/2})ₐ(SiO_{4/2})_{b} (where R mutually independently represents a monovalent organic group, a and b are positive numbers, respectively, and a+b=1 and a/b=0.5 to 1.5).

Component (D) may contain only (a) M units and (b) Q units, but may also include an R₂SiO_{2/2} unit (D unit) and/or RSiO_{3/2} unit (T unit). Note that in the formula, R mutually independently represents a monovalent organic group. The total amount of (a) M units and (b) Q units in component (D) is preferably 50 mass % or more, more preferably 80 mass % or more, and particularly preferably 100 mass %.

Component (D) is a reactive MQ-type organopolysiloxane resin added independently of component (A), so the monovalent organic group (R) is not particularly limited and may be a monovalent hydrocarbon group selected from the aforementioned functional groups R^{A}, alkyl groups, alkenyl groups, aryl groups, aralkyl groups, and halogenated alkyl groups in which a portion of the hydrogen atoms are replaced with a halogen atom such as a fluorine atom, and industrially, a methyl group or a phenyl group may be used. However, at least one of all of the R's in each molecule must be an alkenyl group. The alkenyl group in component (D) may be an alkenyl group with 2 to 8 carbon atoms (C2 to C8 alkenyl), more preferably a vinyl or a hexenyl group, and the other Rs may be an alkyl group (particularly including a methyl group) or a phenyl group. Furthermore, component (D) may include a hydroxyl group or a hydrolyzable group such as an alkoxy group or the like, or may be an organopolysiloxane resin in which the amount of the hydroxyl group or hydrolyzable group is reduced by hydrolyzing these hydrolyzable groups with a silylating agent such as trimethylsilane or the like.

Component (D) is an optional component, and thus may be blended in an amount of 0.0 to 50 parts by mass relative to 100 parts by mass of component (A), preferably 0.5 to 35 parts by mass, and particularly preferably 1.0 to 20 parts by mass.

### [(E) Organohydrogenpolysiloxane]

Component (E) is an organohydrogenpolysiloxane having at least two or more silicon-bonded hydrogen atoms in a molecule, and is a component that functions as a crosslinking agent in the curable organopolysiloxane composition described above. Specifically, the alkenyl groups in components (A) and (D) react in the presence of (C) a hydrosilylation reaction catalyst to form a pressure-sensitive adhesive layer that is a semi-cured product. The pressure-sensitive adhesive layer has excellent initial adhesive strength to the substrate, but includes unreacted photo-curable silicon-bonded functional groups (R^{A}), so the pressure-sensitive adhesive strength is greatly reduced by two-step curing triggered by high energy beam irradiation, and thus easy releaseability is exhibited.

The molecular structure of component (E) is not particularly restricted, and includes cyclic organohydrogen polysiloxanes having at least three silicon-bonded hydrogen atoms in each molecule, linear chains, partially branched linear chains, branched chains, and resinous forms, but linear chains, partially branched linear chains, and resinous forms are preferable. Furthermore, the viscosity of component (E) at 25° C. is not limited, but is preferably within a range of 1 to 10000 mPa·s or 1 to 1000 mPa·s. Furthermore, at least one or more type of linear, branched, or resinous organohydrogen polysiloxanes having at least three or more silicon-bonded hydrogen atoms in each molecule may be used. Furthermore, component (E) may be a mixture of two or more of the aforementioned organohydrogenpolysiloxanes.

The silicon atom bonded to the silicon atom bonded-hydrogen atom in component (E) is not limited, and examples include silicon atoms on a terminal of a molecular chain and/or other silicon atoms. Furthermore, examples of a silicon-bonded organic group in component (E) include monovalent hydrocarbon groups with 1 to 12 carbon atoms that do not have an aliphatic unsaturated bond, and specific examples include: methyl groups, ethyl groups, propyl groups, butyl groups, pentyl groups, hexyl groups, octyl groups, and other alkyl groups with 1 to 12 carbon atoms; phenyl groups, tolyl groups, xylyl groups, and other aryl groups 6 to 12 carbon atoms; benzyl groups, phenethyl groups, and other aralkyl groups with 7 to 12 carbon atoms; and 3-chloropropyl groups, 3,3,3-trifluoropropyl groups, and other halogen-substituted alkyl groups with 1 to 12 carbon atoms, and methyl groups and phenyl groups are preferable.

Examples of this component (E) include 1,1,3-3-tetramethyl disiloxanes, 1,3,5,7-tetramethyl cyclotetrasiloxanes, tris(dimethyl hydrogensiloxy) methylsilanes, tris(dimethyl hydrogensiloxy) phenylsilanes, 1-glycidoxypropyl-1,3,5,7-tetramethyl cyclotetrasiloxanes, 1,5-glycidoxypropyl-1,3,5,7-tetramethyl cyclotetrasiloxanes, 1-glycidoxypropyl-5-trimethoxysilyl ethyl-1,3,5,7-tetramethyl cyclotetrasiloxanes, methyl hydrogen polysiloxanes blocked with a trimethylsiloxy at both terminals of the molecular chain, dimethyl siloxane/methyl hydrogen siloxane copolymers blocked with a trimethylsiloxy group at both terminals of the molecular chain, dimethyl polysiloxanes blocked with a dimethyl hydrogensiloxy group at both terminals of the molecular chain, dimethyl siloxane/methyl hydrogen siloxane copolymers blocked with a dimethyl hydrogensiloxy group at both terminals of the molecular chain, methyl hydrogen siloxane/diphenyl siloxane copolymers blocked with a trimethyl siloxane group at both terminals of the molecular chain, methyl hydrogen siloxane/diphenyl siloxane/dimethyl siloxane copolymers blocked with a trimethylsiloxy group at both terminals of the molecular chain, hydrolysis condensates of trimethoxysilane, copolymers containing (CH₃)₂HSiO_{1/2} units and SiO_{4/2} units, copolymers containing (CH₃)₂HSiO_{1/2} units, SiO_{4/2} units, and (C₆H₅)SiO_{3/2} units, or two or more mixtures thereof.

Examples of cyclic organohydrogenpolysiloxanes include those expressed by the following formula:

[(R³HSiO)ₘ₃(R³₂SiO)ₘ₄]

In the formula, the value of m3+m4 is within a range of 3 to 20, m3 is a value of 3 or higher, and m4 is a value of 0 or higher. R³ represents a monovalent hydrocarbon group having 1 to 10 carbon atoms, excluding alkenyl groups, and examples include the same groups as R², preferably methyl or phenyl groups.

The straight chain or branched chain organohydrogen polysiloxane having at least two or more silicon-bonded hydrogen atoms in the molecule is an organohydrogen polysiloxane such as a polyorganohydrogen siloxane or a copolymer of organohydrogenpolysiloxane and diorganosiloxane, having at least two or more silicon-bonded hydrogen atoms in a side chain moiety and having the terminals of the molecular chain blocked with a trialkylsiloxy group, aryl dialkylsiloxy group, and the like. The degree of siloxane polymerization ranges from 4 to 500, preferably from 5 to 200.

The amount of component (E) can be selected based on the desired pressure-sensitive adhesive strength and curing properties, but from the perspective of initial adhesive strength and easy releasability triggered by high energy beam irradiation which is the issue of the present invention, a range of 0.1 to 5 parts by mass in 100 parts by mass of the aforementioned component (A) is preferred, 0.5 to 4.5 parts by mass is more preferable, and 1.0 to 3.5 parts by mass is especially preferable. If the amount of component (E) used is less than the lower limit described above, the crosslinking agent may be insufficient, resulting in insufficient heat curability of the composition, but if the amount exceeds the upper limit described above, the change in pressure-sensitive adhesive strength of the pressure-sensitive adhesive layer before and after irradiation with high energy beam becomes small, and thus the object of the present invention may not be achieved. In addition, with regard to the amount of component (E) used, the molar number of silicon-bonded hydrogen atoms in component (E) to the molar number of aliphatic unsaturated carbon-carbon bonds such as alkenyl groups and the like in the composition (hereinafter, “SiH/Vi ratio”) is preferably in a range of 0.1 to 5.0, more preferably in a range of 0.1 to 2.0, and particularly preferably in a range of 0.1 to 0.75. Within this range, the overall crosslink density can be appropriately adjusted, and the desired properties for storage elastic modulus and close adhesion of the cured product can be achieved. On the other hand, if the SiH/Vi ratio is less than the lower limit, adhesive residue or the like may occur when the cured product is closely adhered to the substrate. If the ratio exceeds the upper limit, unreacted SiH groups may become excessive, resulting in unstable close adhesion properties of the cured product.

### [(F) Hydrosilylation Reaction Catalyst]

Component (F) is a hydrosilylation reaction catalyst, and is a component that promotes the hydrosilylation reaction of component (E) with aliphatic unsaturated carbon-carbon bonds such as alkenyl groups and the like in component (A) and other optional components by heating or the like.

Examples of hydrosilylation reaction catalysts include platinum-based catalysts, rhodium-based catalysts, and palladium-based catalysts, with platinum-based catalysts being preferable in that they markedly accelerate the curing of the present composition. In particular, a platinum-alkenylsiloxane complex is preferable. Examples of this alkenyl siloxane include 1,3-divinyl-1,1,3,3-tetramethyldisiloxane, 1,3,5,7-tetramethyl-1,3,5,7-tetravinylcyclotetrasiloxane, alkenyl siloxanes in which some of the methyl groups of these alkenyl siloxanes are substituted with groups selected from a group consisting of nitriles, amides, dioxolanes, and sulfolanes, ethyl groups, phenyl groups, or the like, and alkenyl siloxanes in which the vinyl groups of these alkenyl siloxanes are substituted with allyl groups, hexenyl groups, or the like. In particular, 1,3-divinyl-1,1,3,3-tetramethyldisiloxane is preferably used because of the favorable stability of this platinum-alkenylsiloxane complex, and is preferably added in the form of an alkenylsiloxane solution. In addition, from the perspective of improving handling workability and pot life of the composition, these hydrosilylation reaction catalysts may be thermoplastic resin microparticles containing a hydrosilylation reaction catalyst, which are catalysts dispersed or encapsulated in a thermoplastic resin such as a silicone resin, a polycarbonate resin, an acrylic resin, or the like, and particularly may be thermoplastic resin microparticles containing a hydrosilylation reaction catalyst that contains platinum. Note that as the catalyst for promoting the hydrosilylation reaction, a non-platinum-based metal catalyst such as iron, ruthenium, iron/cobalt, or the like may be used.

While the amount of the hydrosilylation reaction catalyst is not particularly limited in the present invention, the amount of the platinum-based metal with regard to the total amount of solid fraction in the composition is within a range of 0.1 to 200 ppm, and may be within a range of 0.1 to 150 ppm, within a range of 0.1 to 100 ppm, or within a range of 0.1 to 50 ppm. Herein, the platinum-based metal is a metal element of group VIII including platinum, rhodium, palladium, ruthenium, and iridium. However, in practical use, the amount of the platinum-metal excluding the ligands of the hydrosilylation reaction catalyst is preferably within the range described above. Note that the solid fraction is a component that forms the cured layer (primarily a main agent, an adhesion-imparting component, a crosslinking agent, a catalyst, and other non-volatile components) when the curable organopolysiloxane composition according to the present invention is subjected to a curing reaction and does not include volatile components such as solvents that volatilize at the time of heat curing.

When the amount of the platinum-based metal in the curable organopolysiloxane composition according to the present invention is 50 ppm or less (45 ppm or less, 35 ppm or less, 30 ppm or less, 25 ppm or less, or 20 ppm or less), discoloration or coloration of the transparent adhesion layer may be suppressible, in particular, after curing or when heated or exposed to a high energy beam such as UV rays. Meanwhile, from the perspective of the curability of the organopolysiloxane composition, the amount of the platinum-based metal is no lower than 0.1 ppm, because when the amount is lower than this lower limit, this may cause curing defects.

### [(G) Cure Retarder]

The curable organopolysiloxane composition of the present invention may optionally contain a curing retarder. A curing retarder is added to inhibit a crosslinking reaction between the aliphatic unsaturated carbon-carbon bond-containing groups and the silicon bonded hydrogen atoms in the composition, to extend usable time at ambient temperature, and to improve storage stability. Therefore, in practical use, the component is nearly essential to the curable organopolysiloxane composition of the present invention.

Specifically, examples of the curing retarder include acetylenic compounds, ene-yne compounds, organic nitrogen compounds, organic phosphorus compounds, oxime compounds, and phosphorus compounds. Specific examples include: alkyne alcohols such as 3-methyl-1-butyne-3-ol, 3,5-dimethyl-1-hexyne-3-ol, 3-methyl-1-pentyne-3-ol, 1-ethynyl-1-cyclohexanol, phenyl butanol, and the like; ene-yne compounds such as 3-methyl-3-pentene-1-yne, 3,5-dimethyl-1-hexyne-3-yne, and the like; methylalkenylcyclosiloxanes such as 2-ethynyl-4-methyl-2-pentene, 1,3,5,7-tetramethyl-1,3,5,7-tetravinylcyclotetrasiloxane, 1,3,5,7-tetramethyl-1,3,5,7-tetrahexenylcyclotetrasiloxane, and the like, as well as benzotriazoles.

The phosphorus-containing hydrosilylation reaction retarder may be at least one selected from a group consisting of phosphine compounds, phosphoric acid compounds, phosphonic acid compounds, phosphine oxide compounds, phosphite compounds, and phosphonic acid compounds. Examples include components described in Japanese Unexamined Patent Application 2007-308542, such as 1,3-bis(diphenylphosphino)propane and the like.

From the perspective of the curing behavior of the composition, the curable organopolysiloxane composition of the present invention is preferably curable at 80 to 200° C., with an increase in viscosity of 1.5-fold after 8 hours at room temperature following the preparation of the composition. Suppressed thickening is important from the perspective of handling workability, pot life, and post-curing properties, because curing at a high temperature (80 to 200° C.) above a certain level ensures curability. Note that such a composition can be achieved by selecting a suitable combination and compounded amounts of each of the components described above, the hydrosilylation catalyst, and the curing retarder.

### [(H) Release Modifier]

An arbitrary release modifier may be added to the composition of the present invention, separately from the above-described components (A) to (G) (particularly, component (B2)). The viscosity required for coating with the curable organopolysiloxane composition, as well as the pressure-sensitive adhesion, hardness, crosslink density, and the like of the cured or semi-cured product can be adjusted by using this component; furthermore, the release properties or the like of the cured product may be improved.

These release modifiers are not restricted in type and quantity as long as they are compatible with the other components and can improve the release properties of the cured product. Commonly known release modifiers selected from fluorosilicones having a perfluoroalkyl group, or the like, MQ type silicone resins which may optionally have a lower or higher alkenyl group, α,ω-diolefin compounds, medium to long chain olefin compounds having an alkenyl group only at one end, and linear organopolysiloxanes which may optionally have an alkenyl group, or mixtures thereof, may be added within a range for adjusting the required release force.

For example, in the present invention, a linear organopolysiloxane that may optionally have an alkenyl group may be added independently of component (B2) and the like as a release modifier. Specific examples of such release modifier include trimethylsiloxy-terminated or vinyldimethylsiloxy-terminated polydimethylsiloxanes, polyphenylmethylsiloxanes, poly(dimethylsiloxane-diphenylsiloxane) copolymers, poly(dimethylsiloxane-trifluoropropylmethylsiloxane) copolymers, and poly(dimethylsiloxane-nonafluorohexylmethylsiloxane) copolymers, having a viscosity at 25° C. in the range of 1.5 to 1000000 mPa·s. However, these components are not a limitation.

### [(I) Organic Solvent]

The composition according to the present invention can be designed as a composition with little or no solvent by selecting constituent components that have relatively low viscosity, but (1) an organic solvent may be optionally added. The organic solvent may be used as a diluent to disperse or dissolve each component in order to improve the coatability and wettability of the composition on the substrate, or may be unavoidably included as solvents associated with other raw material components.

While not particularly limited, as long as the technical effects of the present invention are not impaired, the type of organic solvent used herein may be a compound which is soluble with all of the constituent components in the composition or a portion of the constituent components, and a type having a boiling point of 80° C. or higher and of 200° C. or lower is preferably used. The type of solvent can be a non-halogenated or halogenated solvent, aromatic hydrocarbon solvent, aliphatic hydrocarbon solvent, ester solvent, alcohol solvent, ether solvent, chlorinated aliphatic hydrocarbon solvent, volatile oil solvent, or the like, and combinations of two or more types can be used depending on the coatability, wettability, and the like.

The amount of organic solvent is less than 0 to 60 mass %, particularly preferably less than 50%, and substantially in a range of 0 to 30%, based on the total mass of the composition of 100 parts by mass. In particular, in the composition of the present invention, the solid fraction concentration that forms a solid fraction by the curing reaction can be easily designed to be in a range of 30 to 100% by mass of the entire composition.

### [Other Optional Components]

The curable organopolysiloxane composition of the present invention may optionally contain components other than the components described above, to an extent that does not impair the technical effects of the present invention. For example, the composition may contain: an adhesion promoter; a non-reactive organopolysiloxane other than component (B) such as a polydimethyldiphenylsiloxane; an antioxidant such as a phenol-type, a quinone-type, an amine-type, a phosphorus-type, a phosphite-type, a sulfur-type, or a thioether-type antioxidant; a light stabilizer such as triazoles or benzophenones; a flame retardant such as a phosphate ester-type, a halogen-type, a phosphorus-type, or an antimony-type flame retardant; and one or more types of antistatic agents consisting of a cationic surfactant, an anionic surfactant, a non-ionic surfactant, or the like. Note that in addition to these components, pigments, dyes, inorganic microparticles (reinforcing fillers, dielectric fillers, conductive fillers, thermally conductive fillers), and the like can be optionally blended.

The method of preparing the curable organopolysiloxane composition of the present invention is not particularly limited and is performed by homogeneously mixing the respective components. An organic solvent may be added as necessary, and the composition may be prepared by mixing using a known stirrer or kneader. Note that the present composition has hydrosilylation reactivity when heated, and therefore is preferably mixed at a temperature of less than 100° C., preferably less than 50° C.

### [Method of Use as Adhesive Layer]

The curable organopolysiloxane composition according to the present invention has both heat curability and photo-curability by irradiation with a high energy beam because the composition contains the aforementioned component (A). In particular, the semi-cured product obtained by heat curing functions as a pressure-sensitive adhesive layer with excellent initial adhesive strength, the pressure-sensitive adhesive strength to the substrate of the pressure-sensitive adhesive layer is greatly reduced by irradiating with a high energy beam, and the composition can be easily removed by forming an easily releasable cured product. The method of use will be described below.

### [Application and Heat Curing]

The curable organopolysiloxane composition according to the present invention is applied to a substrate to form a coating film, which is then heated to a temperature of 80 to 200° C., preferably 90 to 150° C., to provide a semi-cured product that functions as a pressure-sensitive adhesive layer with excellent initial adhesive strength due to the hydrosilylation reaction. Note that the heating time required for curing can be selected according to the thickness of the pressure-sensitive adhesive layer and the amount of catalyst used, but is generally in a range of 0.5 to 90 minutes. The pressure-sensitive adhesive layer obtained by heat curing the composition according to the present invention contains unreacted silicon-bonded functional groups (R^{A}), and thus maintains further photo-curing reactivity triggered by irradiation with a high energy beam.

Examples of application methods include gravure coating, offset coating, offset gravure, roll coating, reverse roll coating, air knife coating, curtain coating, and comma coating. The coating amount can be designed at a desired thickness in accordance with the application such as a display device. For example, the thickness of the pressure-sensitive adhesive layer after curing may be from 1 to 1000 μm, from 5 to 900 μm, or from 10 to 800 μm. However, there is no limitation thereto.

The semi-cured product prior to the photo-curing reaction has sufficient initial pressure-sensitive adhesive strength. For example, when designing a pressure-sensitive adhesive layer with a thickness of 75 μm, a pressure-sensitive adhesive layer can be designed with a pressure-sensitive adhesive strength to an SUS plate at a tensile rate of 300 mm/min using the 180° peeling test method according to JIS Z 0237 that is 30 gf/25 mm or higher, preferably within a range of 30 to 2000 gf/25 mm. Note that the thickness (75 μm) described above is the thickness of the cured layer itself serving as a reference for objectively defining the pressure-sensitive adhesive strength of the cured layer according to the present invention. It goes without saying that the curable organopolysiloxane composition of the present invention is not limited to a thickness of 75 μm and may be used as a cured layer or a pressure-sensitive adhesive layer of an arbitrary thickness.

[Change in Pressure-Sensitive Adhesive Strength by Irradiation with High Energy Beam]

The pressure-sensitive adhesive layer, which is a semi-cured product obtained by heat curing, undergoes a further photo-curing reaction triggered by irradiation with a high energy beam, greatly reducing the pressure-sensitive adhesive strength, forming a hard cured product that is easily releasable and that does not leave adhesive residue on the substrate, or the like, allowing the layer to be easily released from the substrate. Specifically, when the organopolysiloxane semi-cured product obtained by a heat curing reaction is closely adhered to another substrate, the pressure-sensitive adhesive strength to the substrate decreases by 10% or more, preferably 30% or more, and particularly preferably 50% or more, before and after a photo-curing reaction by irradiation with a high energy beam. Note that such changes in the pressure-sensitive adhesive strength can be quantitatively measured by a pressure-sensitive adhesive strength measurement test using the aforementioned SUS plate or the like.

In particular, the present invention has the distinct advantage that the aforementioned component (A) and component (B) (preferably, component (B1) and component (B2) or component (B3) in combination) can be designed to achieve a strong initial adhesion as described above, and a decrease in adhesion to the substrate in a range of 30 to 99% before and after the light-curing reaction triggered by irradiation with a high energy beam.

Examples of the high energy beam used in the photo-curing reaction (also referred to as active energy beam) include UV rays, electron beams, radiation beams, and the like, but UV rays are preferable from the perspective of practicality. As the UV ray generating source, a high-pressure mercury lamp, a medium-pressure mercury lamp, a Xe—Hg lamp, a deep UV lamp, or the like is suitable, and in particular, UV ray irradiation with a wavelength of 280 to 400 nm, preferably with a wavelength of 300 to 400 nm is preferable, and a light source with a plurality of light emission bands may be used.

Although the irradiation amount of the high energy beam can be designed as appropriate, when the UV irradiation amount (irradiance) is 100 mJ/cm² to 10,000 mJ/cm², and preferably 1,000 mJ/cm² to 5,000 mJ/cm² as the integrated light intensity, the high energy beam irradiation triggers a favorable change in the pressure-sensitive adhesive strength of the pressure-sensitive adhesive layer according to the present invention. Note that the high energy beam irradiation may be performed with the substrate sandwiched in between, so long as the substrate supporting the adhesive layer of the present invention does not absorb electromagnetic waves in the above wavelength region. In other words, if a certain amount of irradiation is feasible, high energy beam irradiation may be performed over a cover material such as a substrate, protective film, or the like.

### [Properties Related to Transparency, Color Tone, or Coloration and Discoloration of Pressure-Sensitive Adhesive Layer]

The pressure-sensitive adhesive layer (including semi-cured and cured products) obtained by curing the curable organopolysiloxane composition and organopolysiloxane pressure-sensitive adhesive composition according to the present invention may be substantially transparent, semi-transparent or opaque, and the transparency can be designed according to the application of the pressure-sensitive adhesive layer. When it is visually transparent, or more objectively, when the value for air is 100%, the transmittance of light at a wavelength of 450 nm of the pressure-sensitive adhesive layer formed from a cured layer having a thickness of 100 μm is 80% or higher, and preferably 90% or higher, and may be designed so as to be 95% or higher. On the other hand, with the pressure-sensitive adhesive or the like for temporary retaining or the like when light transmissivity is not required, a semi-transparent to opaque pressure-sensitive adhesive layer may be used with a filler component or additive which impairs colorability or light transmittance.

[Method of Use as Pressure-Sensitive Adhesive Layer, Pressure-Sensitive Adhesive Sheet with Change in Pressure-Sensitive Adhesive Properties Before and After High Energy Beam Irradiation]

In order to improve adhesion with an adherend, the pressure-sensitive adhesive layer of the present invention may be subjected to a surface treatment such as primer treatment, corona treatment, etching treatment, plasma treatment, and the like on the surface of the pressure-sensitive adhesive layer according to the present invention or the substrate. However, the adhesion layer of the present invention has excellent adhesion to a substrate of a display device and the like as described above. Therefore, these steps may be added, as required, to further improve adhesion with the adherend, with a higher production efficiency capable of being achieved by eliminating these steps.

The curable organopolysiloxane composition according to the present invention is semi-cured by a condensation reaction by applying the composition to a release liner, then heating under the temperature conditions described above, and after the release liner is peeled off and the composition is attached to a film-like substrate, a tape-like substrate, or a sheet-like substrate (hereinafter, referred to as a “film-like substrate”), or applied to a film-like substrate, curing by heating at the temperature conditions described above so as to form a pressure-sensitive adhesive layer on the surface of the substrate can be performed. As described above, the pressure-sensitive adhesive layer has excellent initial adhesion and contains a photo-curable functional group derived from component (A), which is triggered by high energy beam irradiation to decrease pressure-sensitive adhesive strength and change pressure-sensitive adhesive properties on easy releasability.

A laminate body, provided with a cured layer, in particular, a film-like cured layer, obtained by curing the organopolysiloxane composition according to the present invention on a film-like substrate, may be used as adhesive tape, detachable protective film, adhesive bandage, low temperature support, transfer film, label, emblem, and decorative or explanatory sign. Further, a cured layer obtained by curing the organopolysiloxane composition according to the present invention may be used to assemble automobile parts, toys, electronic circuits, or keyboards. Alternatively, a cured layer formed by curing the organopolysiloxane composition according to the present invention, particularly a film-like adhesive layer, may be used in the protection, construction, and use of a laminated touch screen or flat panel display.

Examples of the substrates include paperboard, cardboard, clay coated paper, polyolefin laminated paper, especially polyethylene laminated paper, synthetic resin films/sheets, natural fiber cloth, synthetic fiber cloth, artificial leather cloth, and metal foil. In particular, synthetic resin films and sheets are preferable, and examples of synthetic resins include polyimides, polyethylenes, polypropylenes, polystyrenes, polyvinyl chlorides, polyvinylidene chlorides, polycarbonates, polyethylene terephthalates, cyclopolyolefins, and nylons. When heat resistance is required in particular, a heat-resistant synthetic resin film such as a polyimide, polyetheretherketone, polyethylene naphthalate (PEN), liquid crystal polyacrylate, polyamide-imide, polyether sulfone, and the like is preferable. At the same time, for applications such as a display device in which visibility is required, a transparent substrate and specifically a transparent material such as a polypropylene, polystyrene, polyvinylidene chloride, polycarbonate, polyethylene terephthalate, PEN, and the like is preferable.

The substrate is preferably a film-like or sheet-like substrate. The thickness thereof is not particularly limited and can be designed with a desired thickness in accordance with the application. Furthermore, in order to improve the adhesion between a supporting film and cured adhesive layer, a supporting film subjected to a primer treatment, corona treatment, etching treatment, or plasma treatment may be used. Furthermore, the surface of the film-like substrate on the opposite side as the cured layer or cured adhesive layer surface may be subjected to surface treatments such as a treatment for scratch prevention, grime prevention, fingerprint adhesion prevention, anti-glare, anti-reflection, anti-static, or the like.

The pressure-sensitive adhesive layer according to the present invention may be a single layer or a multilayer structure obtained by laminating two or more pressure-sensitive adhesive layers in accordance with the required properties. The multilayered pressure-sensitive adhesive layer may be obtained by mutually adhering films prepared one layer at a time, or by performing a process of coating and curing the curable silicone composition a plurality of times, such as on a film substrate with a release layer or the like.

The pressure-sensitive adhesive layer according to the present invention may serve as another functional layer selected from a dielectric layer, conductive layer, heat dissipation layer, insulating layer, reinforcing layer, and the like, in addition to providing bonding or closely adhering between members. In particular, the pressure-sensitive adhesive layer, which is a semi-cured product obtained by heat curing the curable organopolysiloxane according to the present invention, has excellent initial adhesion and contains a photo-curable functional group derived from component (A), which is triggered by high energy beam irradiation to decrease pressure-sensitive adhesive strength and change pressure-sensitive adhesive properties on easy releasability, thereby forming a cured adhesion layer that can be very easily removed from a substrate surface by high energy beam after fixing or adhering with the desired device or process. Therefore, the pressure-sensitive adhesive layer is very useful for temporary fixing or the like of a temporary functional layer or a supposedly detachable functional layer.

For the case of a pressure-sensitive adhesive layer obtained by heat curing the curable organopolysiloxane composition of the present invention, in particular, a pressure-sensitive adhesive sheet with a change in pressure-sensitive adhesive properties before and after high energy beam irradiation, the pressure-sensitive adhesive layer is preferably handled as a laminated body film closely adhered in a releasable state on a film substrate provided with a release layer with release coating capability. The release layer may also be referred to as a release liner, a separator, a release layer, or a release coating layer, and may preferably be a release layer having a release coating function such as a silicone-based release agent, a fluorine-based release agent, an alkyd-based release agent, a fluorosilicone-based release agent, or the like, or may have physically fine irregularities formed on a substrate surface, such that the adhesive layer of the present invention will not easily adhered to the substrate. In particular, the laminated body according to the present invention preferably has a release layer obtained by curing a fluorosilicone release agent as the release layer.

The pressure-sensitive adhesive layer according to the present invention has the characteristic pressure-sensitive adhesive properties described above and can achieve transparency and low haze, and thus is useful as an elastic adhesion layer or temporary fixing layer, as a member of various electronic apparatuses or electrical devices, and as a protective film during processing of a semiconductor wafer. Similarly, the cured product is also useful as an electronic material, a member for a display device, or a member for a transducer (including sensors, speakers, actuators, and generators), and a suitable application for the cured product is a member of an electronic component or display device. The cured product according to the present invention may be transparent or opaque, and in particular, a film-shaped cured product, particularly a substantially transparent protective film, is suitable as a member of a display panel or display, and is particularly useful in so-called touch panel applications in which a device, particularly an electronic device, can be operated by touching a screen with a fingertip or the like. Note that the cured product layer of the present invention is not required to have transparency, and may be suitable for applications as a film or sheet-like member that is used in sensors, speakers, actuators, and the like that require a certain degree of elasticity or flexibility of the adhesive layer itself.

### [Use as an Adhesive Tape]

Articles having a cured layer formed by curing the curable organopolysiloxane composition of the present invention may include adhesive tape, especially protective tape intended to be attached and detached, and are characterized by providing sheet-like members made of textile products such as the aforementioned synthetic resin films/sheets, metal foil, woven fabric, non-woven fabric, paper, or the like, and the aforementioned adhesive layer. The type of adhesive tape is not particularly limited, and includes insulating tapes, heat-resistant tapes, solder masking tapes, mica tape binders, temporary attaching tapes (including in particular temporary attaching tapes for silicone rubber parts, and the like), and splicing tapes (including in particular splicing tapes for silicone release paper).

In particular, the cured product, especially the cured layer, which is made by curing the curable organopolysiloxane composition of the present invention, achieves a strong initial adhesive strength of 30 gf/25 mm or more as measured by a predetermined method, and because the cured product contains a light-curing functional group derived from component (A), curing can be triggered by a high energy beam in order to reduce the pressure sensitive adhesive strength to the substrate to be in a range of 30 to 99%. Furthermore, the adhesion layer used for temporary fixing and the substrate can be adhered relatively firmly, and the appearance is stable, so after use, the product can easily be removed from the surface of the substrate by irradiating with an ultraviolet light beam or the like, so the product is particularly suitable for functional films that are used temporarily for display devices, semiconductors, and the like, on the premise that they can be temporarily attached and then removed. In particular, as described below, the present invention is extremely useful as a pressure-sensitive adhesive for temporarily fixing for use when manufacturing a display device such as a CRT display, liquid crystal display, plasma display, organic EL display, inorganic EL display, LED display, surface-conduction electron-emitter display (SED), field emission display (FED), and other display devices, or touch panels using the display devices.

### [Laminate Body and Adhesive Sheet]

A laminate body with a cured adhesive layer made by curing the curable silicone composition may be formed on a film substrate, and suitably, these film substrates may be provided with a release layer for the cured adhesive layer.

The laminate body of the present invention preferably has a sheet-like substrate with at least one release layer, and the release layer is preferably in contact with the cured adhesive layer. Therefore, the cured adhesive layer can easily be peeled off from the sheet-like substrate. The release agent included in the release layer is not particularly limited, and examples may include the same release agents as described above.

In particular, the laminate body may be able to handle the adhesive layer separated from the film-like substrate alone, or there may be two film-like substrates.

Specifically, it is possible to provide:
a film-like substrate;
a first release layer formed on the film-like substrate;
a pressure sensitive adhesive layer formed by applying and curing the pressure sensitive
adhesive layer-forming organopolysiloxane composition on the release layer; and
a second release layer laminated on the adhesive layer.

Similarly, the laminate body of the above form may be formed, for example, by coating and curing the curable organopolysiloxane composition described above on one of the release layers formed on the film-like substrates to form a pressure-sensitive adhesive layer, and then laminating another release layer on the adhesive layer.

Furthermore, a laminate body with this form may be produced, for example, by interposing the curable silicone composition described above between the first film-like substrate and the second film-like substrate, to form a layer to a certain thickness by pressing or rolling while heating, and then curing the composition.

The first sheet substrate may be provided with a first release layer, or the first sheet substrate itself may be provided with releasability. Similarly, the second sheet substrate may be provided with a second release layer, or the second sheet substrate itself may be provided with releasability. When the first sheet substrate and/or the second sheet substrate is provided with a first release layer and/or a second release layer, the cured adhesive layer is preferably in contact with the first release layer and/or the second release layer.

For example, the sheet substrate having releasability includes a sheet substrate made of a material having releasability such as a fluororesin film, or a sheet substrate made of a material having no or low releasability such as a polyolefin film to which a release agent such as silicone, fluororesin, or the like has been added. On the other hand, the sheet substrate provided with the release layer includes, for example, a polyolefin film and the like, coated with a release agent such as silicone, fluororesin, or the like.

The aforementioned laminate body can be used, for example, by peeling the adhesive layer from the film-like substrate after applying the cured adhesive layer to the adherend.

The thickness of the adhesion layer (pressure-sensitive adhesive layer) obtained by heat curing the curable organopolysiloxane composition according to the present invention is preferably 5 to 10,000 μm, preferably 10 μm or more or 8,000 μm or less, and particularly preferably 20 μm or more and 5,000 μm or less.

### [Member for Display Panel or Display]

The adhesion layer (pressure-sensitive adhesive layer) obtained by heating and curing the curable organopolysiloxane composition of the present invention can be used for protection, construction, or use in a laminate touch screen or flat panel display, and the specific method of use can be a commonly known method of use of adhesion layers (e.g., silicone PSA, silicone adhesives, and silicone sealing agents), without particular limitation.

### INDUSTRIAL APPLICABILITY

The application of the curable organopolysiloxane composition of the present invention, and a pressure-sensitive adhesive layer obtained by semi-curing/curing the same are not limited to those disclosed above, and a film provided with the cured product obtained by curing the composition can be used in various display devices for displaying characters, symbols and images. The surface shape of such a display device may be a curved shape or a bowed shape rather than a flat surface, with examples thereof including curved displays or curved transmission screens used in automobiles (including electric vehicles), aircraft, or the like, in addition to various flat panel displays (FPDs). Furthermore, these display devices may have an additional touch panel function that allows input operations by touching icons, notification displays, or operation buttons for executing functions or programs on the screen or display using a finger. Application thereof is possible as a device for CRT displays, liquid crystal displays, plasma displays, organic EL displays, inorganic EL displays, LED displays, surface-conduction electron-emitter displays (SEDs), field-emission displays (FEDs), and other display devices, or touch panels using the display devices. Moreover, the cured product obtained by curing the composition has excellent adhesion to a substrate and viscoelastic properties, and can be used as a film-like or sheet-like member, which is a member for transducers such as a membrane for speakers (including a sensor, speaker, actuator, and generator), in addition to also being capable of being used as a sealing layer or adhesive layer used in a secondary battery, fuel cell, or solar cell module.

### EXAMPLES

Hereinafter, the present invention is described in detail with reference to the examples and comparative examples, but the present invention is not limited to the following examples. In addition, due to the nature of the semi-cured product according to the present invention, the high energy beam irradiation is not performed at the same time as heat curing.

### (Measurement of Molecular Weight of Organopolysiloxane Component)

Weight average molecular weight (Mw) and number average molecular weight (Mn) of organopolysiloxane components such as the organopolysiloxane resin were determined using Waters gel permeation chromatography (GPC) with tetrahydrofuran (toluene) as the solvent and standard polystyrene conversion.

### Synthesis Example 1

333.0 g of a 60% xylene solution of MQ resin expressed by the following average formula:

(Me₃SiO_{1/2})_{0.411}(Me₂ViSiO_{1/2})_{0.06}(SiO₂)_{0.46}(SiO(OH))_{0.07}

(vinyl content: 2% by mass, hereinafter referred to as the Vi-MQ resin), 200.0 g of a chain polydimethylsiloxane capped with silanol groups at both ends and having a viscosity of 13 Pa·s, and 133.0 g of toluene were mixed in a 1000-mL four-neck flask.

5 g of 30% aqueous ammonia was added to the resulting mixture, and the mixture was stirred at 40° C. for eight hours. Then, toluene was refluxed at 120° C. to distill off the ammonia and water. 666 g of a resin-linear structure containing—organopolysiloxane block copolymer solution expressed by the following average structural formula:

(Me₃SiO_{1/2})_{0.20}(Me₂ViSiO_{1/2})_{0.03}(Me₂SiO)_{0.50}(SiO₂)_{0.24}(SiO(OH))_{0.03}

was obtained.

### Synthesis Example 2

666.0 g of the condensation reaction product obtained in the 1000 mL 4-neck flask (Synthesis example 1) was mixed with 26.3 g of 3-(1,1,3,3-tetramethyldisiloxanyl)propylmethacrylate and 0.1 g of 4-methoxyphenol. 2 ppm of a toluene solution of platinum/1,3-divinyltetramethyldisiloxane complex, calculated as the mass of the platinum, was added to the mixture, stirred for four hours while the temperature was adjusted to 40° C. to 50° C., and then the consumption of the SiH was confirmed by IR spectroscopy. The reaction mixture was then cooled and stirring was stopped. 692 g of the resin-linear structure-containing organopolysiloxane block copolymer solution expressed by the average structural formula:

(Me₃SiO_{1/2})_{0.206}(Me₂ViSiO_{1/2})_{0.013}(Me₂R^{A}SiO_{1/2})_{0.017}(Me₂SiO)_{0.50}(SiO₂)_{0.24}(SiO(OH))_{0.03}

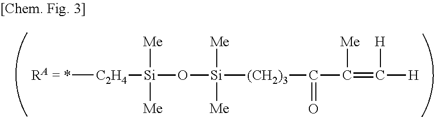

was obtained.

### Examples 1 to 7, Comparative Examples 1 to 2

Examples and comparative examples according to the present invention are described below.

### (Preparation of a Curable Silicone Composition)

Pressure-sensitive adhesive compositions containing the curing-reactive organopolysiloxane compositions indicated in each of the examples and comparative examples were prepared as a toluene solution with a concentration of 70%, using the components shown in Table 1. Note that all percentages in the same table refer to mass %. The viscosity and plasticity of each component were measured at 25° C., and the ratio of silicon-bonded hydrogen atoms to the sum of the alkenyl groups in the composition is shown in the table as SiH/Vi.
(a1): Resin-linear structure-containing organopolysiloxane shown in Synthesis Example
(2) (amount of vinyl groups: 0.48 mass %, amount of methacrylate groups: 1.86 mass %)
(a2-1): Organopolysiloxane resin (Vinyl group content: 0.41 mass %, methacrylate group content: 5.19 mass %) expressed by the average composition

M_{0.41}M^{Vi}_{0.01}M^{RA}_{0.05}Q_{0.53}
containing: siloxane units (M units) expressed by Me₃SiO_{1/2};
siloxane units (M^{Vi} units) expressed by ViMe₂SiO_{1/2};
siloxane units (M^{RA} units: R^{A} is a monovalent functional group described in synthesis example 1) expressed by R^{A}Me₂SiO_{1/2}; and
siloxane units (Q units) expressed by SiO_{4/2};
having a weight average molecular weight (Mw) of 78,000 g/mol as measured by GPC using toluene as a solvent
(A2-2): Dimethylsiloxane polymer with a viscosity of 37 Pa·s and blocked at both ends with dimethylvinylsiloxy groups (amount of vinyl groups: 0.10 mass %)
(a′): Resin-linear structure-containing organopolysiloxane shown in Synthesis Example
(1) (amount of vinyl groups: 1.14 mass %)
(b1) Organopolysiloxane resin containing in a molecule a siloxane unit (M unit) expressed by Me₃SiO_{1/2} and a siloxane unit (Q unit) expressed by SiO_{4/2} at a molar ratio of 1.0:1.0 (weight average molecular weight (Mw) of 7,000, as measured by GPC using toluene as a solvent)
(b2) Polydimethylsiloxane raw rubber with a plasticity of 170
(b3) Condensation reaction product of component (b1) and component (b2) at a mass ratio of 60:40
(c) 2,2-dimethoxy-2-phenylacetophenone (Tokyo Chemical Industry Co., Ltd.)
(d) An organopolysiloxane resin (vinyl content 2.40 mass %) containing siloxane units expressed by Me₃SiO_{1/2} (M units), siloxane units expressed by ViMe₂SiO_{1/2} (M^{Vi} units), and siloxane units (Q units) expressed by SiO_{4/2}, in a molar ratio of 0.41:0.06:0.53 and having a weight average molecular weight (Mw) of 7200 as measured by GPC using toluene as a solvent
(e): Dimethylsiloxy-methylhydrogensiloxy copolymer with both ends capped by a trimethylsiloxy group, having a viscosity of 5.2 mPa-s (hydrogen group content of SiH group: 0.75 mass %)
(f): Dimethylsiloxane polymer solution blocked at both ends by vinyldimethylsiloxy groups of a platinum-1,3-divinyl 1,1,3,3-tetramethyldisiloxane complex (approximately 0.7 mass % in platinum concentration)
(g) 1-Ethynyl-1-cyclohexanol (Tokyo Kasei Kogyo Co., Ltd.)
   (Pressure-Sensitive Adhesive Strength Measured Initially and after UV Irradiation)

Each composition was applied to a PET film (available from Toray Co., Ltd., product name: Lumirror (registered trademark) S10, thickness: 50 μm) such that the thickness after curing was 20 μm, after which it was cured for three minutes at 130° C. After leaving for 30 minutes, the sample was cut to a width of 25 mm and a pressure-sensitive adhesive layer surface was attached to a SUS plate (available from Paltech) using a roller to obtain a test piece. The pressure-sensitive adhesive strength (gf/25 mm) measured on a SUS plate at a tensile rate of 300 mm/min using the 180° peel test method in accordance with JIS Z 0237 is shown in Table 1 as “Initial pressure-sensitive adhesive strength”. In addition, the test piece was irradiated with UV rays with a wavelength of 365 nm from a PET surface side using a UV-LED UV irradiation device (available from JATEC) such that the amount of UV irradiation (irradiance) was 2,000 mJ/cm² as an integrated light intensity. The pressure-sensitive adhesive strength (gf/25 mm) of the test piece after UV irradiation was measured in the same manner as described above and is shown in Table 1 as “Pressure-sensitive adhesive strength after UV irradiation”.

TABLE 1

| | Test Example | | | | | | | | |
|---|---|---|---|---|---|---|---|---|---|
| | Example | Example | Example | Example | Example | Example | Example | Comparative | Comparative |
| Component | 1 | 2 | 3 | 4 | 5 | 6 | 7 | Example 1 | Example 2 |
| a1 | 76.5 | 70.8 | 66.9 | 67.5 | 62.4 | 62.5 | | 95.6 | |
| a2-1 | | | | | | | 33.6 | | |
| a2-2 | | | | | | | 33.6 | | |
| a′ | | | | | | | | | 76.5 |
| b1 | 14.3 | 15.2 | 14.3 | | 9.6 | 9.6 | 14.4 | | 14.3 |
| b2 | 4.8 | | | | 3.8 | 3.8 | | | 4.8 |
| b3 | | | 4.8 | 0.9 | | 3.8 | 4.8 | | |
| c | 2.9 | 2.9 | 2.9 | 2.8 | 2.9 | 2.9 | 2.9 | 2.9 | 2.9 |
| d | | 9.6 | 9.6 | 27.5 | 20.1 | 16.3 | 9.6 | | |
| e | 1.0 | 1.0 | 1.0 | 0.8 | 0.7 | 0.6 | 0.6 | 1.0 | 1.0 |
| f | 0.4 | 0.4 | 0.4 | 0.4 | 0.4 | 0.4 | 0.4 | 0.4 | 0.4 |
| g | 0.1 | 0.1 | 0.1 | 0.1 | 0.1 | 0.1 | 0.1 | 0.1 | 0.1 |
| SiH/Vi ratio | 0.47 | 0.31 | 0.36 | 0.16 | 0.17 | 0.17 | 0.22 | 0.41 | 0.21 |
| Initial pressure- | 48 | 950 | 540 | 380 | 200 | 200 | 30 | 8 | 640 |
| sensitive adhesive | | | | | | | | | |
| strength | | | | | | | | | |
| gf/25 mm | | | | | | | | | |
| Pressure-sensitive | 12 | 25 | 8 | 7 | 4 | 9 | 10 | 9 | 808 |
| adhesive strength | | | | | | | | | |
| after UV irradiation | | | | | | | | | |
| gf/25 mm | | | | | | | | | |
| Rate of change in | 25% | 3% | 1% | 2% | 2% | 5% | 33% | 113% * | 126% * |
| adhesive strength | (75%) | (97%) | (99%) | (98%) | (98%) | (95%) | (67%) | | |
| (Rate of decrease) | | | | | | | | | |

* The pressure-sensitive adhesive strength did not decrease, but increased due to ultraviolet irradiation.

As depicted in Table 1, the heat-cured products (=semi-cured products) of the curable organopolysiloxane compositions of the present invention according to Examples 1 to 7 had an initial adhesive strength of 30 gf/25 mm or more and are capable of strong temporary fixing and adhesion between substrates. Furthermore, the pressure-sensitive adhesive layer had pressure-sensitive adhesive strength greatly reduced by UV irradiation, change in pressure-sensitive adhesive properties to be easy releasable, and maintained transparency. Therefore, it is expected to excel in usefulness as a protective film, temporary fixing film, and the like when used in a manufacturing process of a semiconductor wafer and the like and display devices, electronic devices, and the like.

On the other hand, in Comparative Example 1 in which component (B) was not used in combination, sufficient initial adhesive strength could not be achieved, and easy peelability was not achieved. In addition, in Comparative Example 2 in which component (A) was not included, the adhesive strength was greatly increased by ultraviolet irradiation, but easy peelability could not be realized at all.

1. A curable organopolysiloxane composition, comprising:
(A) 100 parts by mass of an organosiloxane component containing one or more (meth)acrylic groups selected from the following component (A1) to component (A3);
(A1) a resin-linear structure-containing organopolysiloxane block copolymer having:
a resinous organosiloxane block X having an acrylic group or methacrylic group and containing a siloxane unit (M^{RA} unit) expressed by R^{A}ₐR^{B}₍₃₋ₐ₎SiO_{1/2} where R^{A} is a silicon atom-bonded functional group containing an acrylic or methacrylic group, R^{B} is a monovalent organic group excluding R^{A}, and a is a number in a range of 1 to 3,
a siloxane unit (M^{Alk} unit) expressed by R^{B′}₃SiO_{1/2} where R^{B′} is a monovalent organic group excluding R^{A} and at least one R^{B′} is an alkenyl group) and a siloxane unit (Q unit) expressed by SiO_{4/2}; and
a chain organosiloxane block Y having a siloxane unit expressed by {R^{C}₂SiO_{2/2}}_{β} (where R^{C} is a monovalent organic group and β is 2 or higher), and having at least one alkenyl group in each molecule;
(A2) an organosiloxane mixture obtained by mixing the following components (A2-1) and (A2-2) at a mass ratio of 1/99 to 80/20;
(A2-1) a resinous organopolysiloxane having an acrylic group or methacrylic group and containing a siloxane unit (M^{RA} unit) expressed by R^{A}ₐR^{B}₍₃₋ₐ₎SiO_{1/2} where R^{A} is a silicon atom-bonded functional group containing an acrylic or methacrylic group, R^{B} is a monovalent organic group excluding R^{A}, and a is a number in a range of 1 to 3;
a siloxane unit (M^{Alk} unit) expressed by R^{B′}₃SiO_{1/2} where R^{B′} is a monovalent organic group excluding R^{A} and at least one R^{B′} is an alkenyl group and a siloxane unit (Q unit) expressed by SiO_{4/2};
(A2-2) a straight chain organopolysiloxane having two alkenyl groups in each molecule;
(A3) an organosiloxane mixture obtained by mixing the following components (A3-1) to (A3-3);
(A3-1) a resinous organosiloxane having an acrylic group or methacrylic group and containing a siloxane unit (M^{RA} unit) expressed by R^{A}ₐR^{B}₍₃₋ₐ₎SiO_{1/2} where R^{A} is a silicon atom-bonded functional group containing an acrylic or methacrylic group, R^{B} is a monovalent organic group excluding R^{A}, and a is a number in a range 1 to 3, and siloxane units (Q units) expressed by SiO_{4/2};
(A3-2) A resinous organopolysiloxane having an alkenyl group and containing a siloxane unit (M^{Alk} unit) expressed by R^{B′}₃SiO_{1/2} where R^{B′} is a monovalent organic group other than R^{A}, and at least one of R^{B′} is an alkenyl group, and a siloxane unit (Q unit) expressed by SiO_{4/2};
(A3-3) a straight chain organopolysiloxane having two alkenyl groups in each molecule;
(B) 1 to 50 parts by mass of a siloxane component not containing a carbon-carbon multiple bond in each molecule; and
(C) 0.1 to 10 parts by mass of a photoradical polymerization initiator.

2. The curable organopolysiloxane composition according to claim 1, further comprising:
0 to 50 parts by mass of an organopolysiloxane resin having at least one alkenyl group in each molecule, and containing a siloxane unit (M unit) expressed by R₃SiO_{1/2} where R mutually independently represents a monovalent organic group) and a siloxane unit (Q unit) expressed by SiO_{4/2},
wherein the mass ratio of M units to each Q unit is in a range of 0.5 to 2.0.

3. The curable organopolysiloxane composition according to claim 1, further comprising: (E) an organohydrogen polysiloxane having at least two silicon atom-bonded hydrogen atoms in each molecule, and (F) a hydrosilylation reaction catalyst.

4. The curable organopolysiloxane composition according to claim 1, wherein at least a portion of component (A) is (A1-1) a resin-linear structure-containing organopolysiloxane block copolymer with a structure linked by a siloxane bond or a silalkylene bond between silicon atoms forming the resinous organosiloxane block X and chain organosiloxane block Y.

5. The curable organopolysiloxane composition according to claim 1, wherein at least a portion of component (A) is (A1-2) a resin-linear structure-containing organopolysiloxane block copolymer containing a resinous organosiloxane block X containing a siloxane unit (M unit) expressed by R^{B″}₃SiO_{1/2} where R^{B″} is an alkyl group or phenyl group, the aforementioned M^{RA} unit, M^{Alk} unit and Q unit, and the sum of the amount of the M unit, M^{RA} unit and M^{Alk} unit to one mole of Q unit is in a range of 0.5 to 2.0 moles.

6. The curable organopolysiloxane composition according to claim 1, wherein at least a portion of component (A) is (A1-1-1) a resinous organopolysiloxane block copolymer having a resin-linear structure containing the aforementioned resinous organosiloxane block X, and a chain organosiloxane block Y having a siloxane unit expressed by {R^{C}₂SiO_{2/2}}_{β1} where R^{C} is a monovalent organic group and β1 is a number in the range 5 to 5000, block X and block Y being connected by siloxane bonds between silicon atoms.

7. The curable organopolysiloxane composition according to claim 1, wherein at least a portion of component (A) is a resin-linear structure containing—organopolysiloxane block copolymer containing (A1-3) a resinous organosiloxane block X where the amount of M^{RA} units per mole of Q units is in a range of 0.02 to 0.50 moles.

8. The curable organopolysiloxane composition according to claim 1, wherein the silicon atom-bonded functional group R^{A} in component (A) is a functional group represented by the following General Formula (1): 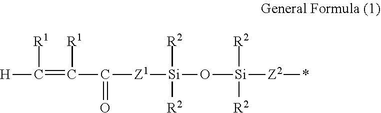
where each R¹ independently represents a hydrogen atom, a methyl group, or a phenyl group, and each R² each independently represents an alkyl group or an aryl group; Z1 represents —O(CH₂)ₘ— where m is a number in the range of 0 to 3; Z² represents a divalent organic group expressed by —CₙH₂ₙ— where n is a number in the range of 2 to 10 bonded to a silicon atom constituting the main chain of the polysiloxane at *.

9. The curable organopolysiloxane composition according to claim 1, wherein component (B) is a siloxane component not having one or more carbon-carbon multiple bonds, selected from the following components (B1) to (B3):
(B1) an organopolysiloxane resin containing a siloxane unit (M unit) expressed by R₃SiO_{1/2} where R mutually independently represents a monovalent organic group not having a carbon-carbon multiple bond) and a siloxane unit (Q unit) expressed by SiO_{4/2} in a molecule, and in which the substance ratio of M units to Q units is in the range of 0.5 to 2.0;
(B2) a straight chain or branched diorganopolysiloxane;
(B3) an organopolysiloxane resin in which the component (B1) and component (B2) are linked by siloxane bonds.

10. The curable organopolysiloxane composition according to claim 1, wherein at least a portion of component B is (B3-1) a condensation reaction product of component (B1) and component (B2) having a number-average molecular weight of 100,000 or higher.

11. The curable organopolysiloxane composition according to claim 1, having both heat curability and photo-curability by irradiation with a high energy beam.

12. The curable organopolysiloxane composition according to claim 1, wherein when the organopolysiloxane semi-cured product obtained by a heat curing reaction is closely adhered to another substrate, the pressure-sensitive adhesive strength to the substrate decreases by 50% or more between before and after a photo-curing reaction by irradiation with a high energy beam.

13. An organopolysiloxane pressure-sensitive adhesive composition, comprising the curable organopolysiloxane composition according to claim 1.

14. An organopolysiloxane pressure-sensitive adhesive layer obtained by curing or semi-curing the curable organopolysiloxane composition according to claim 1.

15. A method of use for an organopolysiloxane pressure-sensitive adhesive composition, the method comprising:
Step (I): applying the organopolysiloxane pressure-sensitive adhesive composition according to claim 13 on a substrate;
Step (II): semi-curing the organopolysiloxane pressure-sensitive adhesive composition applied in the step (I) by a heat curing reaction; and
Step (III): further curing the semi-cured material obtained in Step (II) using a photo-curing reaction by irradiating with a high-energy beam,
wherein the pressure-sensitive adhesive strength of the semi-cured product obtained in Step (II) to another base material is reduced by irradiation with a high energy beam in step (III).
